(19) United States
(12) Patent Application Publication
(10) Pub. No.: US 2019/0360512 A1
(43) Pub. Date: Nov. 28, 2019

(54) SPRING CLAMP WITH TENSION RETAINING CLIP

(71) Applicant: PROGERAL INDUSTRIA DE ARTEFATOS PLÁSTICOS LTDA., Sao Paulo (BR)

(72) Inventors: Marco Antonio Vieira De Campos, Sao Paulo (BR); Rafael Vinicius Vivian, Sao Paulo (BR)

(21) Appl. No.: 16/388,523

(22) Filed: Apr. 18, 2019

(30) Foreign Application Priority Data
May 24, 2018 (BR) 20 2018 10581-2

(51) Int. Cl. F16B 2/24; B25B 27/14

(52) U.S. Cl. CPC F16B 2/245; B25B 27/146

(57) ABSTRACT

A device having a tension retaining clip for use with an annular belt or hose clamping device having radially extending ends. The retaining clip may be used, for example, for compressive emplacement of the annular belt or clamp used to secure a hose. The retaining clip may further include an extraction ring. The radially extending ends of the annular belt may each include first portions extending in radial directions from the belt, and second portions extending perpendicularly from the first portions. The retaining clip may receive and retain the second portions of the extending ends of the annular belt within a retaining cutout, which extends between a free end of the retaining portion and a retaining side surface proximal to the extraction ring. In the retained position, the annular belt may thereby have maximum expanded diameter, due to compression of the extending ends within the cutout relative to one another. The annular belt may be compressed to a smaller diameter by disengaging the tension retaining clip from the extending ends of the annular belt. The cutout may have a cutout surface that extends between the free end of the retaining cutout and the retaining side surface, such that two corners of the cutout are defined thereby. The spring clamp may be disengaged from the annular belt by pulling the extraction ring portion so as to leverably pivot the retaining clip via the retaining clip's extending free end, which may extend toward and contact the annular belt during levered pivoting.

### CROSS-REFERENCE TO RELATED APPLICATION

The present application claims the benefit of priority of applicant's co-pending Brazilian Application No. 20 2018 10581-2, filed on May 24, 2018, the entire contents of which are incorporated herein by reference.

### FIELD OF THE INVENTION

Aspects of the present disclosure relate to a fastener including a spring clamp with a tension retaining clip, including features for use in extraction of the tension retention clip.

### BACKGROUND

Spring clamps are already known, comprising: an annular steel belt, one end of which is formed by a central perimeter slot and two portions lateral to the slot and the opposite end is configured by a narrow passage which is inserted in the slot; said portions lateral to the slot and the narrow portion inserted in the slot have radially outwardly extending portions constituting clamp tensioning ends; said spring clamp is further formed by a clip comprised of a retainer portion which retains the tensioning ends of the annular belt and steel at a position close to one another, wherein said annular steel belt is tensioned and has a larger diameter, which position constitutes a stand-by position for application on a receiving surface; said clip being further formed by an extraction ring in which the user inserts the index finger and pulls the clip to disassemble it from the steel ring belt and this, by the spring effect, has its narrower end more inserted into the slot of the opposing end, whereby said steel annular belt has a smaller diameter and tightens around the receiving surface and the radial tensioning ends of said annular belt and steel are more distant from each other.

This type of clamp is applied, for example, around the end of a hose that has to be attached to the end of a pipe or nozzle or the like. Such a clamp can be seen in U.S. Pat. No. 5,615,457, which is hereby incorporated herein by reference in its entirety.

In spite of the fact that this type of clamp is efficient, a disadvantage can be attributed to it, requiring the user to make a lot of effort to extract the tension retaining clip. This can be a serious problem, for example, in a vehicle assembly line, where a large number of clamps have to be assembled, requiring a lot of effort for assembly line operators.

Thus, a solution to this problem has been desirable.

There remains an unmet need in the related art to provide a spring type clamp with tension retaining clip which overcomes the problem of the above-mentioned problems of the related art.

There remains a further unmet need in the related art to provide a spring clamp that overcomes the problems of the related art and that may be made or produced without undue levels of complexity.

Another objective is to provide a cost-effective clamp.

### SUMMARY OF THE INVENTION

In view of the foregoing problem, in order to overcome it and in order to meet the related unmet needs of the related art, the provision introduced in a spring clamp with tension retaining clip has been developed, which is understood by the usual steel annular belt and tensioning retaining clip, said steel annular belt has the radial tensioning ends provided with perpendicular end portions facing opposite sides; the retaining clip is formed by a retaining portion and an extraction ring, said retaining portion having the opposite end to that containing the extraction ring provided with a perpendicular portion provided with a free end facing the annular steel belt, the retaining portion is further provided with a retaining cutout which is engaged in the end portions of the steel ring belt and the extraction ring of the clip has a larger diameter than usual, said clip, consisting of the end perpendicular portion, by the intermediate retaining segment and by the opposing end extraction ring constitutes a lever arm with support at the free end of the perpendicular end portion which is supported against the annular steel belt, said lever arm having a suitable length so that the force applied on the ring extraction is small and smaller than the force required to perform the same operation on conventional spring clamps.

This construction of the provision inserted in clamp spring with tension retaining clip overcomes the inconvenience with conventional similar clamps since the force applied to the clip extraction ring in the present clamp is less than the corresponding force applied on conventional similar clamps, thus facilitating installation of such clamps and, among other things, meeting various advantages of the present disclosure.

In addition, this clamp presents construction and manufacture simple with respect to the usual and low cost meeting other objectives of the disposition.

Additional advantages and novel features of these aspects will be set forth in part in the description that follows, and in part will become more apparent to those skilled in the art upon examination of the following or upon learning by practice of the disclosure.

### BRIEF DESCRIPTION OF THE FIGURES

The accompanying drawings refer to the provision inserted in clamp spring with tension retaining clip, in accordance with various advantages hereof, in which:

FIG. 1 shows the provision inserted in clamp spring with tension retaining clip and contains numerical references indicative of the usual constructive details of the clamp;

FIG. 2 shows the same figure as above, but having the numerical references indicative of details inserted in the clamp according to the present provision;

FIGS. 3 to 6 show a detail of the clamp with four construction variants of the clip retaining cutout in the annular steel belt; and

FIGS. 7 to 9 show the clamp and the indication of use, in which FIG. 7 is seen the clamp applied around the receiving surface of said clamp with it still in the tensioned position and with a diameter larger than the diameter of the receiving surface; FIG. 8 shows the clamp at the moment at which the tension retaining clip is extracted from the annular steel belt and that, by spring effect, begins to decrease in diameter and close around the receiving surface; and FIG. 9 shows the clamp in the position where the tensioning retaining clip is fully withdrawn from the annular steel belt and is closed and compressed against the receiving surface, securing it to the receiving surface.

### DETAILED DESCRIPTION

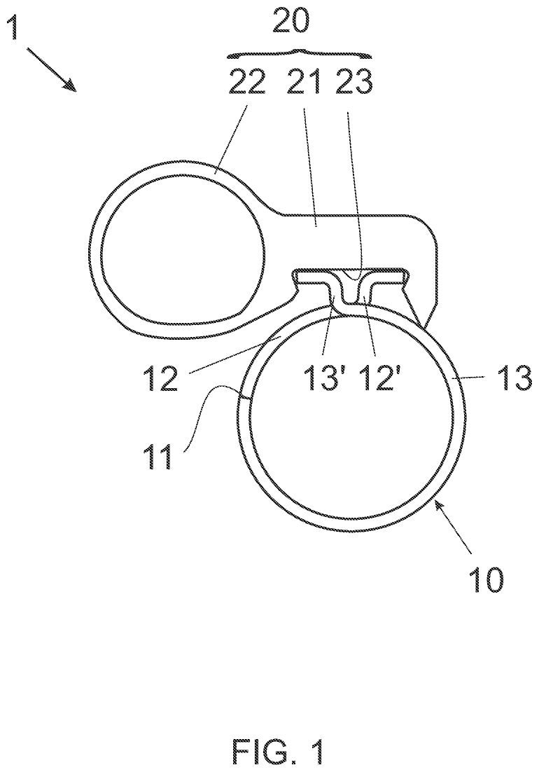

As illustrated in the figures above and is provided in the arrangement, the spring clamp 1 (also interchangeably referred to herein as “the annular belt or base clam and installation device”) is comprised (FIG. 1) of an annular steel belt or hose clamp 10 (also interchangeably referred to herein as “belt” or “clamp”), which is secured around the surface receptor; and by a tension retaining clip 20 of the annular steel belt 10, which keeps it tensioned and of a larger diameter prior to application to the receiving surface and that upon application thereto (the belt 10 being biased to remain at and/or return to a diameter less than the larger diameter) , said clip 20 is extracted and the steel ring 10, constitutive of the clamp, by spring effect, decreases the diameter and clamps around the receiving surface.

The annular steel belt 10 has one end provided with perimeter slot 11 and two belt portions 12 side to the slot 11 and the opposite end provided with narrow end portion 13 which is housed within the slot 11, said belt portions 12 side to the slot 11 and the opposing narrow end portion 13 are folded radially outwardly from the annular belt 10 constituting external radial radially extending tensioning ends 12′ and 13′ (such ends also interchangeably referred to herein as “tensioning ends”), each of the tensioning ends 12′ and 13′ including radially extending first portions attached to the respective belt portions 12, 13 and second portions 30, 31 extending approximately perpendicularly from the respective ends of the radially extending first portions.

The clip 20 is a piece of injected plastic material, formed by a retaining portion 21 tangential to the annular steel belt 10; and by an extraction ring 22, incorporated in one of the ends of the retaining portion 21. Said retaining portion 21 is provided with cutout 23, within which are compressibly retained the tensioning ends 12′ and 13′ of the steel ring 10, arranged at a smaller distance from each other, condition in which said annular steel belt 10 presents tensioned and with an expanded, larger diameter, forming a stand-by position for mounting on a receiving surface. The extraction ring 22 is of sufficient diameter to receive the user's index finger from the clamp.

In this provision and thus constituting the principal object to be protected in the patent, the tensioning ends 12′, 13′ of the annular steel belt 10, the retaining portion 21 of the clip 20, the cutout 23 of the retaining portion 21 (also interchangeably referred to herein as the “retaining cip body), receiver of said tensioning ends 12′, 13′ and the extraction ring 22 of the clip 20 received new geometries, suitable to provide a suitable force system to decrease the force required for extracting the clip 20 from the tensioning ends 12′, 13′ of the annular steel belt 10, upon application of the spring clamp 1 on a receiving surface.

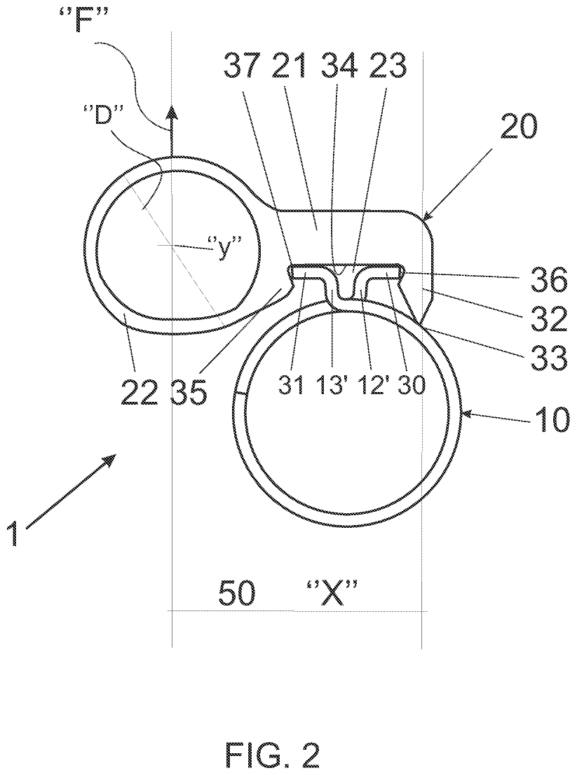

Thus, said tensioning ends 12′, 13′ (FIG. 2) have perpendicular end portions 30, 31, respectively, facing in opposite directions and disposed in a tangential and spaced position relative to the annular steel belt 10.

The retaining portion 21 (portion 21 extending longitudinally in the horizontal direction as shown in the view of FIGS. 1-8) of the clip 20 has the opposite end to the extraction ring 22 provided with a perpendicular end portion 32 e.g., end portion 32 extending approximately perpendicularly to the longitudinal direction of extension of the retaining portion 21), adjacent the free end of the end portion 30 and provided with a pivot free end 33 (pivot end 33 also interchangeably being referred to herein as a “tip”), which abuts the outer surface of the annular steel belt 10.

The cutout 23 has a bottom surface 34 (also interchangeably referred to herein as the “retaining cutout surface”) that lies over the end portions 30, 31 as shown in FIGS. 1-8.

The end of the retention portion 21 opposite that containing the perpendicular end portion 32 and adjacent the extraction ring 22 has a retaining tooth 35 adjacent the free end of end portion 31 (the area of location of the retaining tooth 35 as shown in FIG. 2 being at a side portion of the cutout 23, this side portion of the cutout also interchangeably being referred to herein as the “retaining cutout side surface” or the “retaining side surface”).

The corner 36 defined between the perpendicular end portion 32 and the bottom surface 34 of the cutout 23 and the opposite corner 37 defined there between and the retaining tooth 35 are at acute angle and therein the free ends of the end portions 30, 31 of the tensioning ends 12′, 13′ of the annular steel belt 10.

The extraction ring 22 has larger diameter “D” relative to the diameter of corresponding conventional spring clamp clip rings.

The clip 20, consisting of the perpendicular end portion 32, the intermediate retaining portion 21 and the opposing end extraction ring 22 of the clip 20, constitutes a lever arm 50 with pivot support at the free end 33 of the perpendicular end portion 32 and with drive in the extraction ring 22; said lever arm clip 20 has a length “X”, measured between the free end of pivot 33 of the perpendicular end portion 32 and the center of curvature “Y” of the extraction ring 22, so that a small force “F” applied to the extraction ring 22 and with support at the pivot end 33 of the perpendicular end portion 32 is sufficient to disengage the cutout 23 of the clip 20 from the end portions 30, 31 of the tensioning ends 12′, 13′ of the annular steel belt 10, force ‘F’ is less than the force required for the same extraction operation of the clip in the like conventional spring clamps. The force “F” applied for the extraction of the clip 20 in the clamp 1 of the present provision is at most 66 N.

Although the angled corners 36 and 37 of the cutout 23 have the function of retaining the end portions 30, 31 of the tensioning ends 12′, 13′ of the annular steel belt 10 against the bottom surface 34 of the cutout 23 of the clip 20, said acute angle corners 36, 37 must to have profiles which, in collaboration with the resilience of the plastic material constituting the clip 20, favor the decoupling of said end portions 30, 31 when said clip 20 is drawn from its extraction ring 22.

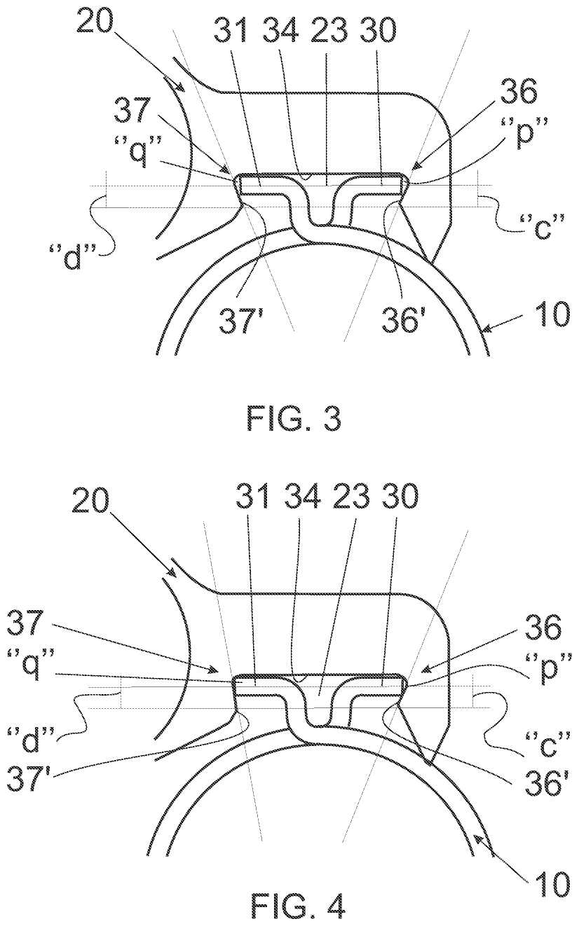

Accordingly, in an embodiment (FIG. 3), said corners 36, 37 have respective acute angles “p” and “q” and the retention ramps 36′, 37′ of said corners 36, 37, have equal lengths “c” and “d” suitable for projecting under the end portions 30, 31 providing retention thereof against the bottom surface 34 of the cutout 23.

In another embodiment (FIG. 4), the corner 36 has an acute angle “p” greater than the acute angle “q” of the opposite corner 37 and the retention ramps 36′, 37′ have lengths “c” and “d” are suitable to project under the end portions 30, 31 providing for their retention against the bottom surface 34 of the cutout 23.

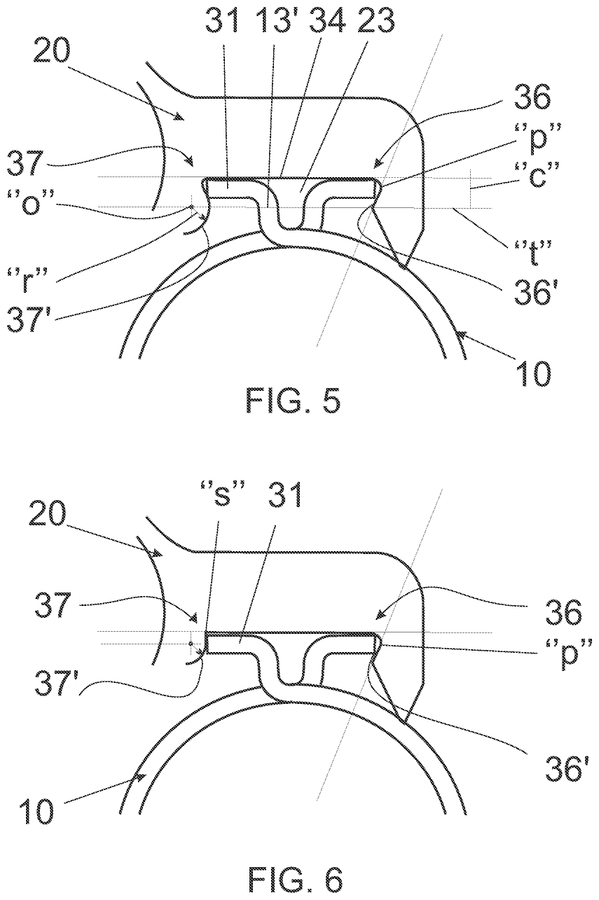

In another embodiment (FIG. 5), the corner 36 has an acute angle “p” and a retaining ramp 36′ with length “c” and the opposite corner 37 does not contain a retaining ramp and in substitution there is provided a raised surface with a center of curvature ‘o’ situated in the plane “t” which contains the free end of the holding ramp 36′ and with a radius ‘r’ suitable for said bulging retaining side surface 37′ to project under the end portion 31 of the tensioning end 13′ and holds said end portion 31 against the bottom surface 34 of the cutout 23.

In other embodiments (FIG. 6), the corner 36 has an acute angle “p” and a retaining ramp (36′) with a length “c” and the opposite corner 37 has a right angle “s” and does not provide for a holding ramp, that there is provided a bulged surface 37′ which is compressed against the free end of the end portion 31, thereby providing retention therein.

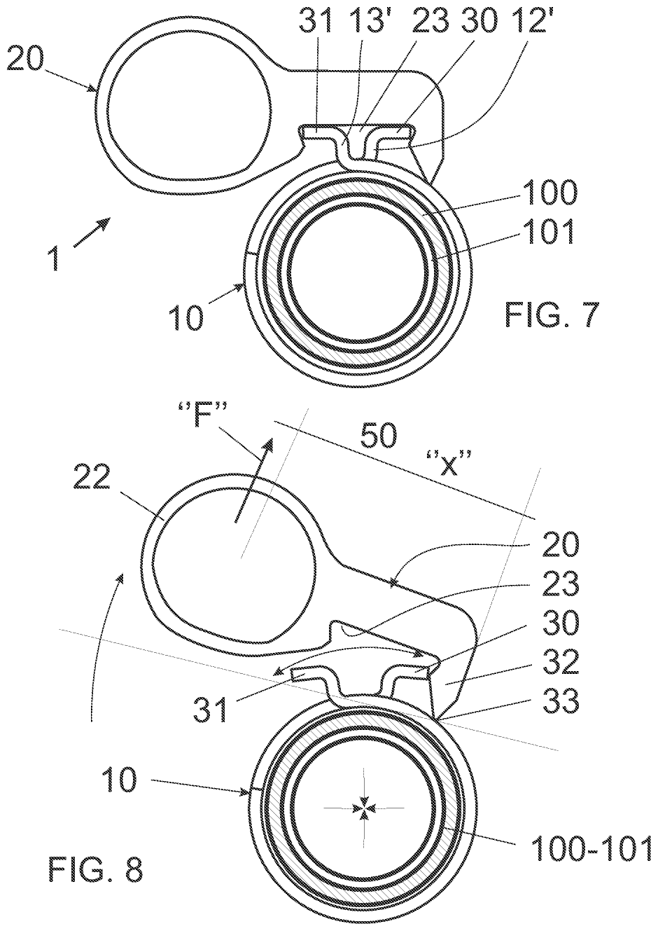

When in operation, initially said spring clamp 1 is tensioned and of greater diameter, configuring a stand-by position to be applied on a receiving surface 100, which may for example be a coupled hose and which must be fixed around the end of a tube 101. In this condition the cutout 23 of the clip 20 is attached in the perpendicular end portions 30, 31 of the tensioning ends 12′, 13′ of the annular steel belt 10, holding said end portions 30, 31 in the closest position to each other, in which the annular steel belt 10 is tensioned and has a larger diameter (FIG. 7).

In order to apply the spring clamp 1 on the receiving surface 100, said spring clamp 1 is introduced around it, which introduction is possible because said spring clamp 1 is in the tensioned position and with a larger diameter than the receiving surface 100.

To attach the spring clamp 1 around the receiving surface 100 (FIG. 8), the user inserts the index finger into the extraction ring 22 of the clip 20 and pulls it in, whereby the cutout 23 of said clip 20 is disengaged from the end portions 30, 31 of the steel ring 10 and this, by spring effect, decreases the diameter and tightens around (e.g., contracts about) said receiving surface 100, thereby providing the attachment between it and the surface 101.

When the clip 20 is pulled through its extraction ring 22, (FIG. 8) the free end 33 of the perpendicular end portion 32 of said clip 20 presses against the annular steel belt 10 and said free end 33 is actuated with a pivot point for the lever arm 50 constituted by the clip 20. As the extension of the lever arm 50 constituted by the clip 20 has the length “x” greater than the corresponding clip length of conventional spring clips, the force “F” that the user leverably applies to extract the clip 20 from the spring clamp 1 of the present patent is a small force relative to the force applied in clip extraction from conventional spring clamps.

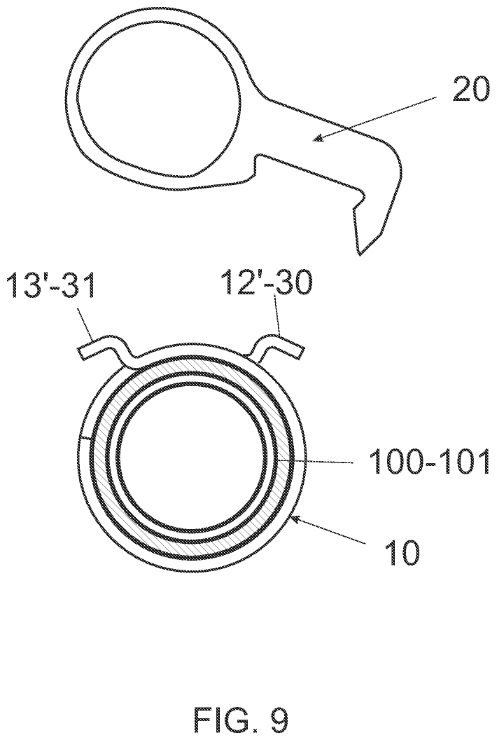

At the end of the total extraction of the clip 20 from the annular steel ring 10 constituting the clamp (FIG. 9), this, by spring effect, distends, decreases in diameter and closes around the receiving surface 100-101, position in which the tensioning ends 12′-30, 13′-31 are the longest distance from each other.

Within the above-described basic construction, spring clamp 1, object of the present invention, may present modifications relating to materials, dimensions, constructive details and/or functional and/or ornamental configuration, without leaving the scope of the requested protection.

Within this, the spring clamp 1 of the present provision can be constructed in several diameters to suit different applications.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1-5. (canceled)

6. An annular belt or hose clamp and installation device, the clamp and installation device comprising:
a belt body biased to remain in a circular cross-sectional shape at a biased diameter, the belt body having an unbiased diameter; the belt body further including:
two radially extending tensioning ends, each of the radially extending tensioning ends including:
a first portion extending from the belt body in a radial outward direction to an extending end, and
a second portion extending approximately perpendicularly from the extending end of the first portion,
an installation device retaining clip portion interoperable with the two radially extending tensioning ends of the belt body, the retaining clip portion including:
a retaining clip body having a longitudinal direction of extension;
a retaining cutout surface formed within the retaining clip body, the retaining cutout surface having a first end and a second end;
a retaining cutout side surface proximal to the first end of the retaining cutout surface; and
a retaining clip end portion extending at the second end of the retaining cutout surface in a direction approximately perpendicularly to the longitudinal direction extension of the retaining clip body, the retaining clip end portion having a tip; and
an installation device extraction ring portion attached to the installation device retaining clip portion proximal to the retaining cutout side surface;
wherein the second portion of each of the radially extending tensioning ends of the belt body are compressibly receivable within the retaining cutout of the retaining clip such that the annular belt or hose clamp body is expanded to a diameter greater than the biased diameter; and
wherein the second portion of each of the radially extending tensioning ends of the belt body, upon being received within the retaining cutout, may be disengaged from the retaining cutout by engaging the extraction ring to pivotably leverage the retaining clip relative to the retaining clip end portion tip.

7. The device of claim 6, wherein, upon the second portion of each of the radially extending tensioning ends of the belt body being disengaged from the retaining cutout, the annular belt or hose clamp body contracts toward the biased diameter.

8. The device of claim 6, wherein the retaining cutout side surface and the retaining cutout surface intersect to form a first corner, wherein the retaining clip end portion and the retaining cutout surface intersect to form a second corner; and wherein a first one of the second portion of the radially extending tensioning ends of the belt body is received at the first corner and a second one of the second portion of the radially extending tensioning ends of the belt body is received at the second corner.

9. The device of claim 8, wherein the first and the second corners each form an acute angle.

10. The device of claim 8, wherein the second corner is formed at an angle of intersection greater than an angle of intersection at which the first corner is formed.

11. The device of claim 6, wherein the retaining cutout side surface extends to a point.

12. The device of claim 6, wherein the retaining cutout side surface forms a convex curve.

13. The device of claim 8, wherein the retaining clip end portion forms a retention ramp.

14. The device of claim 6, wherein the belt body includes a slotted section proximal to a first one of the radially extending tensioning ends, and wherein the second o of the radially extending tensioning ends includes a section of the belt body sized to be slidably received within the slotted section.

15. A device for expanding and facilitating installation of an annular belt or hose clamp, the annular belt or hose clamp including a belt body biased to remain in a circular cross-sectional shape, at a biased diameter and two radially extending tensioning ends, each of the radially extending tensioning ends having a first portion extending from the belt body in a radial outward direction to an extending end, and a second portion extending approximately perpendicularly from the extending end of the first portion, the device comprising:
an extraction ring;
a retaining clip extending at a first end from the extraction ring, the retaining clip including:
a retaining clip body attached at the first end to the extraction ring;
a retaining cutout surface formed within the retaining clip body;
a retaining cutout side surface proximal to the extraction ring at a first end of the retaining cutout surface; and
a retaining clip end portion extending to a tip in a direction approximately perpendicularly from the retaining clip body at a second end of the retaining cutout surface, the second end being opposite the first end;
wherein the second portion of each of the radially extending tensioning ends of the belt body are compressibly receivable within the retaining cutout of the retaining clip such that the annular belt or hose clamp body is expanded to a diameter greater than the biased diameter; and
wherein the second portion of each of the radially extending tensioning ends of the belt body, upon being received within the retaining cutout, may be disengaged from the retaining cutout by engaging the extraction ring to pivotably leverage the retaining clip relative to the retaining clip end portion tip.

16. The device of claim 15, wherein, upon the second portion of each of the radially extending tensioning ends of the belt body being disengaged from the retaining cutout, the annular belt or hose clamp body contracts toward the unbiased diameter.

17. The device of claim 15, wherein the retaining cutout side surface and the retaining cutout surface intersect to form a first corner, wherein the retaining clip end portion and the retaining cutout surface intersect to form a second corner; and wherein a first one of the second portion of the radially extending tensioning ends of the belt body is received at the first corner and a second one of the second portion of the radially extending tensioning ends of the belt body is received at the second corner.

18. The device of claim 17, wherein the first and the second corners each form an acute angle.

19. The device of claim 17, wherein the second corner is formed at an angle of intersection greater than an angle of intersection at which the first corner is formed.

20. The device of claim 15, wherein the retaining cutout side surface extends to a point.

21. The device of claim 15, wherein the retaining cutout side surface forms a convex curve.

22. The device of claim 17, wherein the retaining clip end portion forms a retention ramp.

23. The device of claim 15, wherein the belt body includes a slotted section proximal to a first one of the radially extending tensioning ends, and wherein the second one of the radially extending tensioning ends includes a section of the belt body sized to be slidably received within the slotted section.
